(19) United States
(12) Patent Application Publication
(10) Pub. No.: US 2026/0070085 A1
(43) Pub. Date: Mar. 12, 2026

(54) VIBRATORY DEVICES, SYSTEMS, AND METHODS

(71) Applicant: Vibro Entertainment Corporation, Lakewood, OH (US)

(72) Inventors: Nicholas Carbone, Buffalo, NY (US); Mark Dangelo, Grafton, OH (US)

(73) Assignee: Vibro Entertainment Corporation, Lakewood, OH (US)

(21) Appl. No.: 19/326,010

(22) Filed: Sep. 11, 2025

Related U.S. Application Data
(60) Provisional application No. 63/693,928, filed on Sep. 12, 2024.

(51) Int. Cl. B06B 1/02; B66F 7/06; B66F 7/28

(52) U.S. Cl. CPC B06B 1/0207; B66F 7/065; B66F 7/28

(57) ABSTRACT

A vibratory device is described. A vibratory device has a vibration isolator, a lift, a plurality of elongate members, a platform, and a transducer. The lift has a lift base and a lift deck. The lift base is attached to the vibration isolator. The lift deck is movable between a first position and a second position. The lift deck is disposed a first distance from the lift base in the first position. The lift deck is disposed a second distance from the lift base in the second position that is greater than the first distance. Each elongate member of the plurality of elongate members is attached to the lift deck. The platform is attached to each elongate member of the plurality of elongate members. The transducer is disposed between the lift deck and the platform.

### FIELD

The disclosure relates to the field of vibratory devices, systems, and methods. More particularly, the disclosure relates to vibratory devices used for entertainment purposes.

### BACKGROUND

The entertainment industry is one of the largest and lucrative businesses in the world. However, there is a lack of vibratory devices for creating an immersive experience when viewing a movie, playing a video game, or participating in other similar activities.

A need exists, therefore, for improved vibratory devices, systems, and methods.

### BRIEF SUMMARY OF SELECTED EXAMPLES

Various example vibratory devices, systems, and methods are described.

An example vibratory device comprises has a vibration isolator, a lift, a plurality of elongate members, a platform, and a transducer. The lift has a lift base and a lift deck. The lift base is attached to the vibration isolator. The lift deck is movable between a first position and a second position. The lift deck is disposed a first distance from the lift base in the first position. The lift deck is disposed a second distance from the lift base in the second position that is greater than the first distance. Each elongate member of the plurality of elongate members is attached to the lift deck. The platform is attached to each elongate member of the plurality of elongate members. The transducer is disposed between the lift deck and the platform.

Additional understanding of the vibratory devices, systems, and methods can be obtained by reviewing the detailed description of selected examples, below, and the referenced drawings.

### DESCRIPTION OF FIGURES

FIG. 1 is a perspective view of an example vibratory device.

FIG. 2 is another perspective view of the example vibratory device illustrated in FIG. 1.

FIG. 3 is a partial schematic illustration of the example vibratory device illustrated in FIG. 1.

FIG. 4 is a perspective view of the example vibratory device illustrated in FIG. 1 in a first position.

FIG. 5 is a perspective view of the example vibratory device illustrated in FIG. 1 in a second position.

FIG. 6 is a perspective view of another example vibratory device.

FIG. 7 is another perspective view of the example vibratory device illustrated in FIG. 6.

FIG. 8 is another perspective view of the example vibratory device illustrated in FIG. 6.

FIG. 9 is a partial perspective view of another example vibratory device in a second position.

FIG. 10 is another perspective view of the example vibratory device illustrated in FIG. 9 between a first position and a second position.

FIG. 11 is a partial perspective view of the example vibratory device illustrated in FIG. 9.

FIG. 12 is another partial perspective view of the example vibratory device illustrated in FIG. 9 in a first position.

FIG. 13 is a partial perspective view of a portion of the example vibratory device illustrated in FIG. 9.

FIG. 14 is a perspective view of another example vibratory device.

FIG. 15 is a perspective view of another example vibratory device.

FIG. 16 is a perspective view of an example vibration isolator.

FIG. 17 is a perspective view of another example vibration isolator.

FIG. 18 is a perspective view of another example vibration isolator.

FIG. 19 is a perspective view of another example vibration isolator.

FIG. 20 is a perspective view of another example vibration isolator.

FIG. 21 is a perspective view of an example bracket of a vibration isolator.

FIG. 22 is a schematic view of an example vibratory system.

FIG. 23 is a schematic view of another example vibratory system.

FIG. 24 is a schematic view of another example vibratory system.

FIG. 25 is a schematic view of another example vibratory system.

FIG. 26 is a schematic view of another example vibratory system.

FIG. 27 is a schematic view of another example vibratory system.

FIG. 28 is a schematic view of another example vibratory system.

### DETAILED DESCRIPTION OF SELECTED EXAMPLES

The following detailed description and the appended drawings describe and illustrate various example vibratory devices, systems, and methods of using the same. The description and illustration of these examples enable one skilled in the art to make and use a vibratory device, make a vibratory system, and practice a method of using a vibratory device. They do not limit the scope of the claims in any manner.

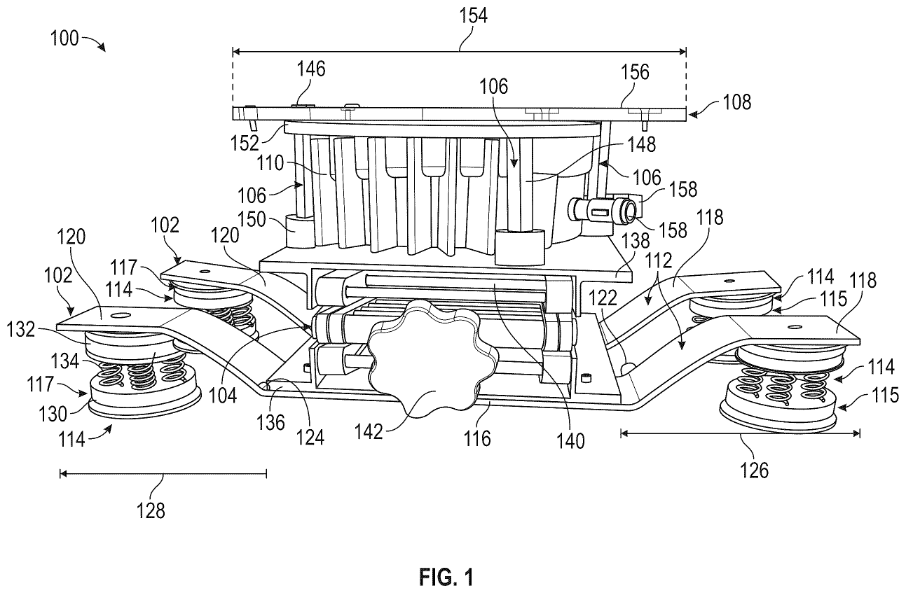

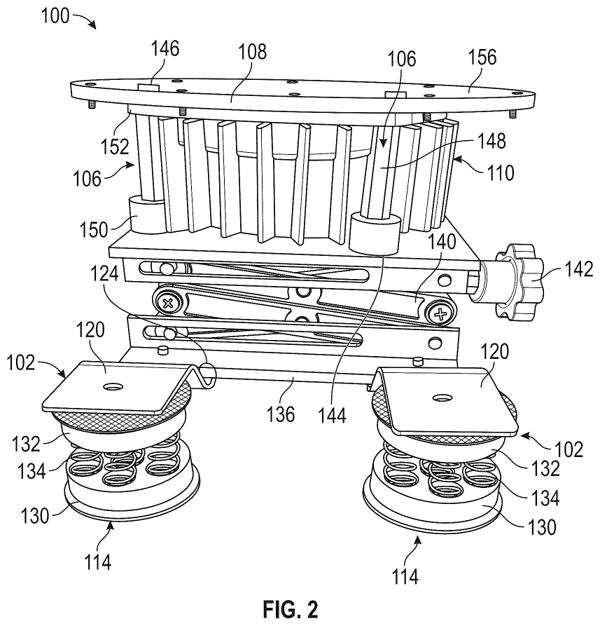

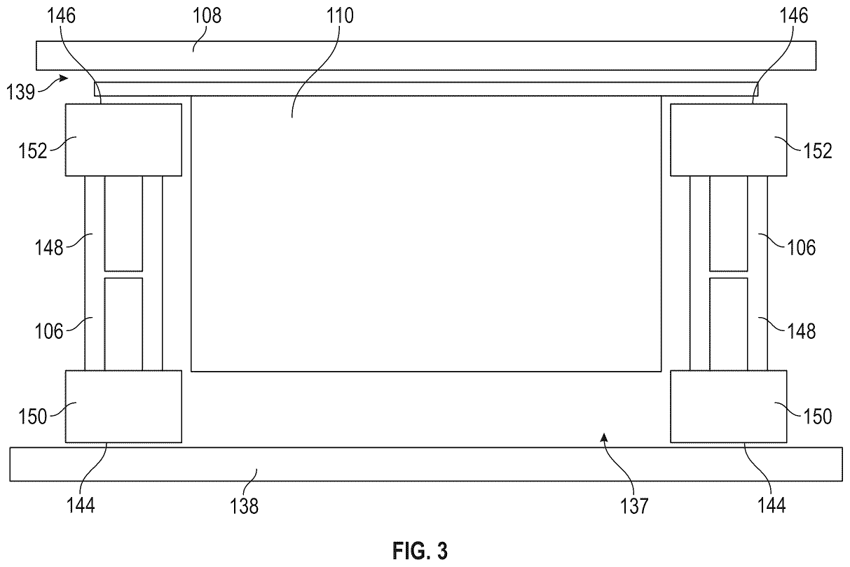

FIGS. 1 through 5 illustrate an example vibratory device 100. The example vibratory device 100 includes a pair of vibration isolators 102, a lift 104, a plurality of elongate members 106, a platform 108, and a transducer 110.

Each vibration isolator 102 includes a bracket 112, as illustrated in FIG. 21, and a plurality of isolator bases 114.

Each bracket 112 has a bracket base 116, a first wing 118, and a second wing 120. The first wing 118 extends from the bracket base 116 and away from the second wing 120 and is disposed at a first angle 122 relative to the bracket base 116. The second wing 120 extends from the bracket base 116 and away from the first wing 118 and is disposed at a second angle 124 relative to the bracket base 116 that is equal to the first angle 122. However, in alternative embodiments, a first angle and a second angle can be different from one another. In the illustrated embodiment, the first wing 118 extends from the bracket base 116 a first distance 126 and the second wing 120 extends from the bracket base 116 a second distance 128 that is equal to the first distance 126. However, in alternative embodiments, a first distance and a second distance can be different from one another. When assembled, the first wing 118 extends the first distance 126 from the lift 104 and the second wing 120 extends the second distance 128 from the lift 104 that is equal to the first distance 126. However, in alternative embodiments, a first distance and a second distance can be different from one another.

A first isolator base 115 of the plurality of isolator bases 114 is attached to the first wing 118 and a second isolator base 117 of the plurality of isolator bases 114 is attached to the second wing 120 of each bracket 112. Each isolator base 114 has a first portion 130, a second portion 132, and at least one spring 134 disposed between the first portion 130 and the second portion 132. In the illustrated embodiment, the first portion 130 comprises a base platform, the second portion 132 comprises a top platform, and each isolator base 114 includes four springs 134. However, in alternative embodiments, an isolator base can include any suitable number of springs such as one, at least one, two, a plurality, three, four, five, six, seven, more than seven, and any other number considered suitable for a particular embodiment.

While each vibration isolator 102 has been illustrated as including the bracket 112, a vibration isolator can omit a bracket and include only one or more isolator bases. The inclusion of a bracket provides a base with a larger footprint relative to those that do not include a bracket, which in turn provides a greater surface area for the distribution of vibrational energy. As a result, the energy produced by an included transducer is spread over a larger area, reducing the intensity of the vibration at any single point. Furthermore, vibration isolators that include a bracket also provide other benefits such as, enhanced stability, dissipation of energy, structural damping, mode shapes and frequencies, improved load distribution, lower stress concentrations, enhanced material damping, geometric stiffness, mass effect, wider support footprint, frequency modulation, interference effects, energy reflection, isolation mechanisms, reduced amplification factors, foundation interaction, and/or multi-layer construction. In addition, downward vibration pressures from an included transducer create direct vector forces into the floor. By using a bracket that includes a first wing and a second wing to create a wider base, the intensity of vibrations is absorbed before the vibrations reach the floor. Some advantages of using a vibration isolator with springs include providing independent vibration touch points that can uniquely deal with uneven surfaces, such as floors, because of the flexibility the springs provide. This ensures there is constant contact with a surface, such as a floor.

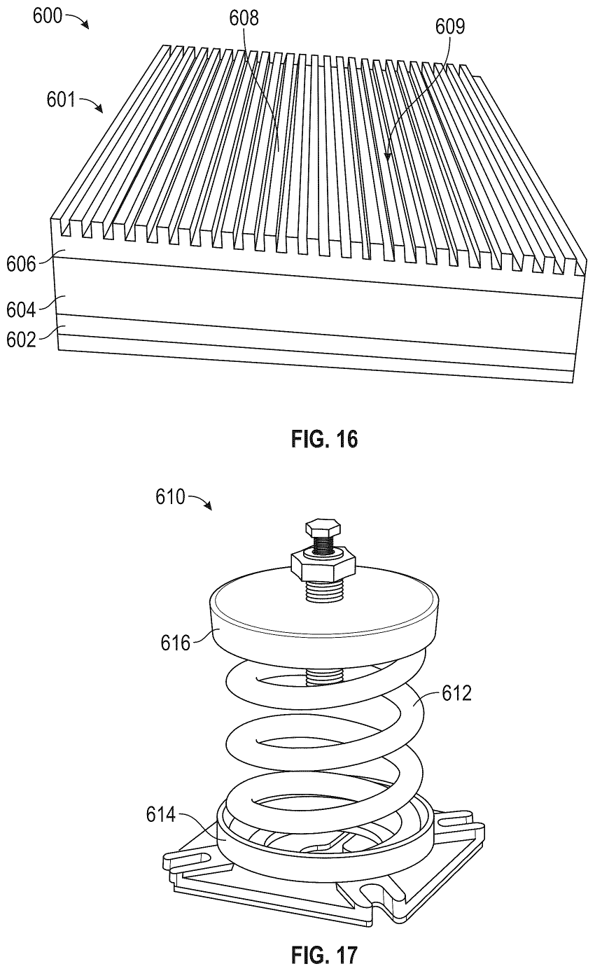

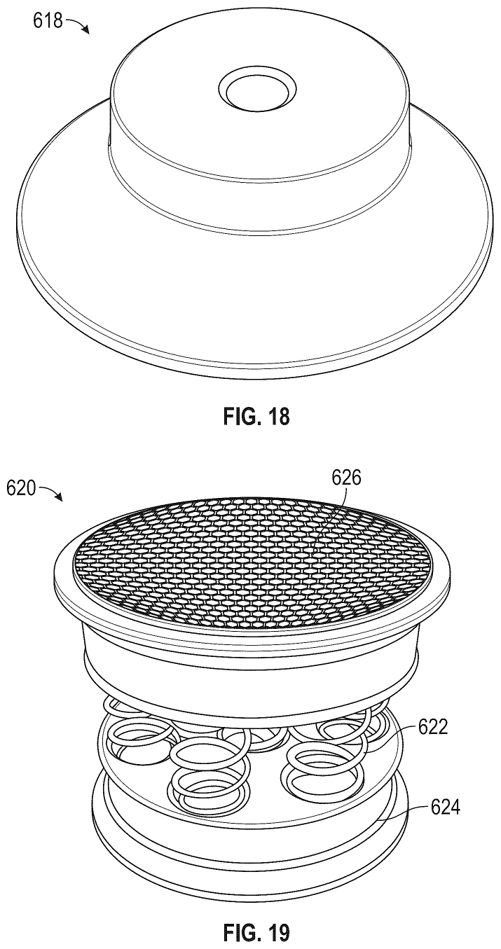

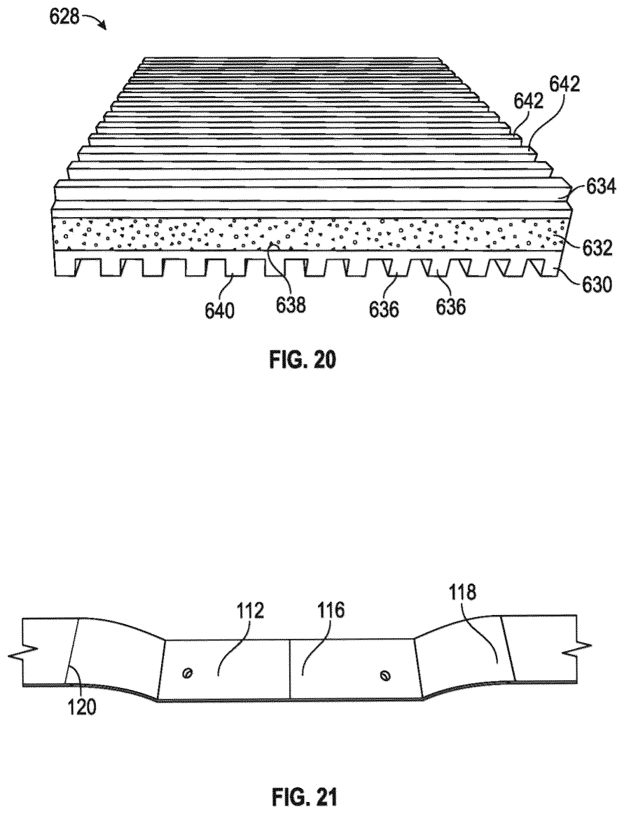

Additional examples of vibration isolators can be found in each of FIGS. 16, 17, 18, 19, and 20. Each vibration isolator illustrated in these figures may be used with or without a bracket, similar to that illustrated in FIGS. 1, 2 and 21, and be directly attached to a lift, or indirectly attached to a lift via a bracket. FIG. 16 illustrates an example vibration isolator 600 that comprises a foam pad 601 that has a first layer 602, a second layer 604, and a third layer 606. The first layer 602 comprises a first foam layer having a first density. The second layer 604 comprises a second foam layer having a second density different from the first density. The third layer 606 comprises a third foam layer having a third density that is different than the first density and the second density. The third layer 606 includes a pattern 608 cut into the upper surface 609 of the third layer 606. FIG. 17 illustrates another example vibration isolator 610 that comprises a single spring 612 disposed between a first portion 614 and a second portion 616. Also, the illustrated vibration isolator does not include a bracket having a first wing, a second wing, or a bracket base. FIG. 18 illustrates another example vibration isolator 618 that is formed of rubber. FIG. 19 illustrates another example vibration isolator 620 that has a plurality of springs 622 disposed between a first portion 624 and a second portion 626. FIG. 20 illustrates another example vibration isolator 628 that comprises a first layer 630, a second layer 632, and a third layer 634. The first layer 630 is formed of a polymer and has a plurality of ridges 636 that extend away from a first layer first side 638 to a first layer second side 640. The second layer 632 is formed of a cork material that is adhered to the first layer 630. The third layer 634 is formed of a polymer, is adhered to the second layer 632, and has a plurality of ridges 642 that run perpendicular to the ridges 636 of the first layer 630. These examples of vibration isolators do not include a bracket. However, the vibration isolators illustrated in FIGS. 16 through 20 could include a bracket similar to that illustrated in each of FIGS. 1, 2, and 21.

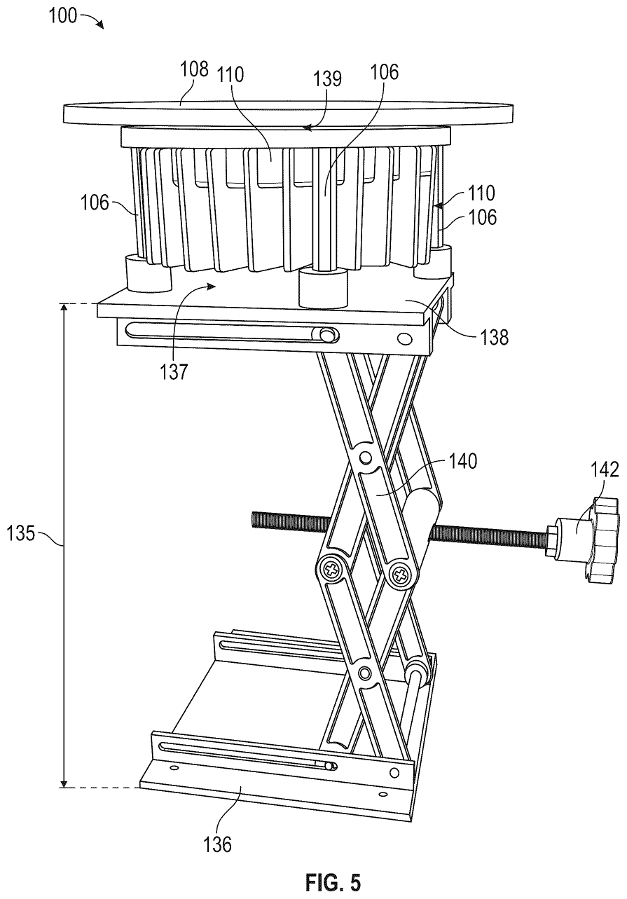

In the illustrated embodiment, the lift 104 includes a lift base 136, a lift deck 138, lift arms 140 connecting the lift base 136 and the lift deck 138, and a lift actuator 142. The lift deck 138 is moveable between a first position, as illustrated in FIGS. 1 through 4, and a second position, as illustrated in FIG. 5 by adjusting the lift actuator 142.

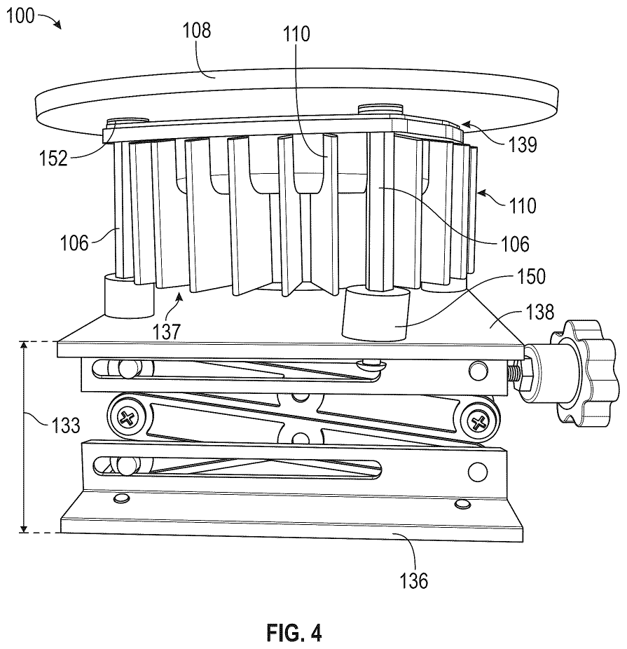

The lift base 136 is attached to each vibration isolator 102. The lift base 136 is attached to each bracket base 116 of the vibration isolators 102 by a plurality of fasteners (not shown). However, in alternative embodiments in which a vibration isolator does not include a bracket, a vibration isolator can be directly attached to a lift base by a plurality of fasteners and/or using an adhesive. The actuator 142 is attached to the lift arms 140 and is configured to move the lift deck 138 between its first position and its second position. The lift deck 138 is disposed a first distance 133 from the lift base 136 when the lift deck 138 is in the first position, as shown in FIG. 4. The lift deck 138 is disposed a second distance 135 from the lift base 136 when the lift deck 138 is in the second position, as shown in FIG. 5. The second distance is greater than the first distance. In the illustrated embodiment, the lift 104 is a scissor lift. However, any suitable lift can be included in a vibratory device, such as linear actuators, hydraulic lifts, air bag jacks, pneumatic lifts, telescopic mechanisms, scissor jack actuators, linear actuators on a scissor lifting mechanism, hydraulic floor car jacks with crank handles, hydraulic scissor jacks, electric hydraulic car jacks, linear actuators, hydraulic bottle jacks, scissor lift tables, RV stabilizing jacks, rotational lifts, expandable scissor jacks, hydraulic scissor lifts, and any other lift considered suitable for a particular embodiment.

Each elongate member 106 of the plurality of elongate members 106 is attached to the lift deck 138 and the platform 108. In the embodiment shown, the plurality of elongate members 106 comprises four elongate members 106. However, in alternative embodiments, any suitable number of elongate members can be used, such as at least one, two, a plurality, three, four, five, six, seven, eight, nine, ten, more than ten, and any other number considered suitable for a particular embodiment.

Each elongate member 106 of the plurality of elongate members 106 has an elongate member first end 144, an elongate member second end 146, and includes a strut 148, a first spacer 150, and a second spacer 152. The first spacer 150 is disposed on the strut 148 at a first location and the second spacer 152 is disposed on the strut 148 at a second location that is different than the first location and such that the first spacer 150 is free of contact with the second spacer 152. In the embodiment shown, the first spacer 150 is disposed between the lift deck 138 and second spacer 152, and the second spacer 152 is disposed between the first spacer 150 and the platform 108. In the embodiment shown, the first spacer 150 of each elongate member of the plurality of elongate members 106 only contacts one elongate member of the plurality of elongate members 106 and the second spacer 152 contacts each elongate member of the plurality of elongate members 106 (e.g., is a plate that contacts each elongate member of the plurality of elongate members 106). However, in alternative embodiments, a first spacer can contact each elongate member of a plurality of elongate members and/or a second spacer can only contact one elongated member of a plurality of elongate members. Each of the first spacer 150 and the second spacer 152 can be formed of any suitable material, such as vulcanized rubber. Each of the elongate members 106 in the illustrated embodiment are approximately 45 mm in length measured from the elongate member first end 144 to the elongate member second end 146. However, an elongate member included in a vibratory device can have any suitable length.

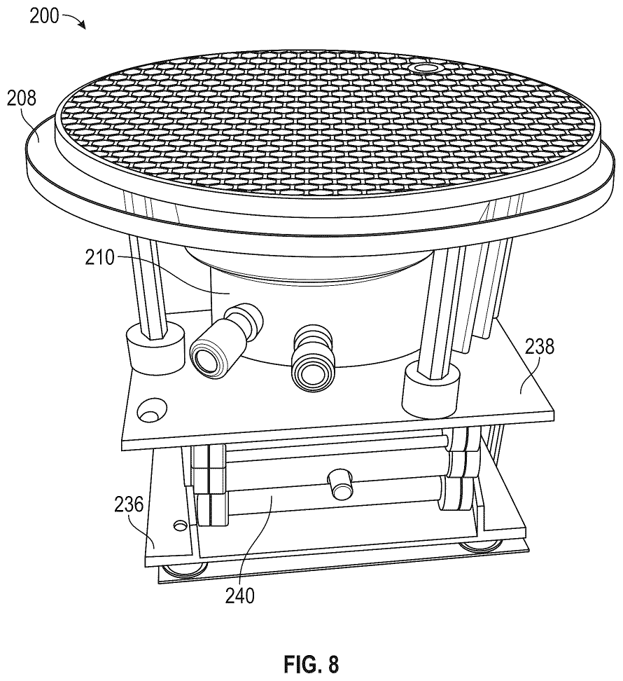

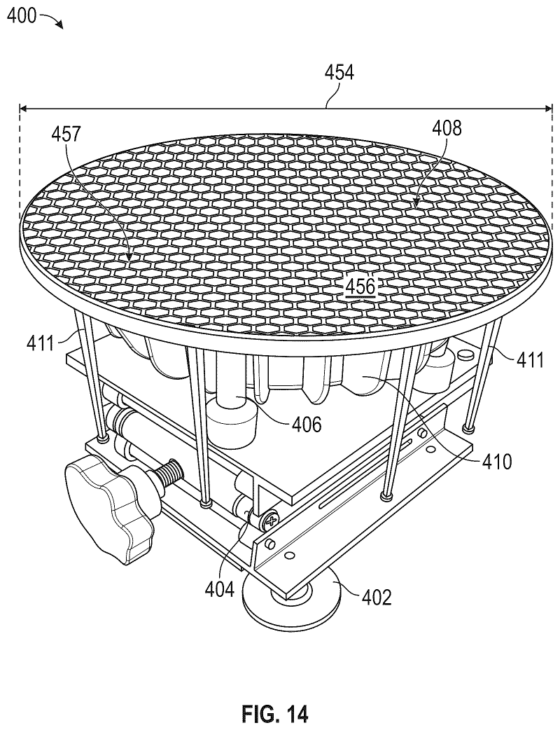

The platform 108 is attached to each elongate member 106 of the plurality of elongate members 106 using a fastener, such as a threaded member and/or a bolt. In the illustrated embodiment, the platform 108 is cylindrical, has a top surface length 154 of about 8 in., and is formed of polycarbonate. However, in alternative embodiments, a platform can be any suitable shape, such as, but not limited to, a cube, a rectangular prism, a cuboid, or any other shape considered suitable for a particular embodiment. In addition, the platform 108 can have any suitable top surface length 154, such as those greater than, or less than, 8 in., and be formed of any suitable material, such as plexiglass. Although not illustrated, a vibration feedback pad, such as illustrated in FIGS. 8 and 14, can be disposed on a platform top surface 156. The inclusion of a vibration feedback pad provides a mechanism for eliminating, or preventing, vibrational feedback. In addition, the inclusion of a vibration feedback pad provides a thermal shield between two solid structures (e.g., the platform 108 and the surface to which the platform 108 is intended to contact), reducing heat created between the structures. The vibration feedback pad can optionally include a plurality of honeycomb shaped indentations that assist with absorbing vibration feedback produced by the vibratory device 100.

In the illustrated embodiment, the transducer 110 is disposed between the lift deck 138 and the platform 108 such that the transducer 110 is free of contact with the lift 104 (e.g., lift deck 138) and the platform 108. As shown in FIG. 4, a first gap 137 is disposed between the lift deck 138 and the transducer 110, that is approximately 6 mm to approximately 10 mm, and a second gap 139 is disposed between the transducer 110 and the platform 108 that is approximately 2 mm to approximately 4 mm. However, a gap can have any suitable size, such as those less than 2 mm and those greater than 10 mm. The transducer 110 contacts each elongate member 106 of the plurality of elongate members 106. In the embodiment shown, the transducer 110 is disposed on, and contacts, the first spacer 150 and the second spacer 152 of each elongate member 106 of the plurality of elongate members 106. The second spacer 152 is disposed between the platform 108 and the transducer 110. Positioning the first spacer 150 and the second spacer 152 in the arrangement shown and described reduces, or eliminates, vibrations and heat produced via contact between the platform 108 and the transducer 110 and between the lift deck 138 and the transducer 110. To further reduce the amount of vibration between the platform 108 and the transducer 110, alternative embodiments may include additional spacers disposed between a platform and a transducer.

In the illustrated embodiment, the transducer 110 is a 50 W transducer. However, any suitable transducer can be used, such as transducers in the range between about 30 W to about 100 W. The transducer 110 includes at least one connection point 158 which is configured to connect the transducer 110 with an entertainment system and/or power supply, not illustrated. When the transducer 110 is connected to an entertainment system, the vibratory device 100 is positioned at a first location and the entertainment system is positioned at a second location that is different than the first location.

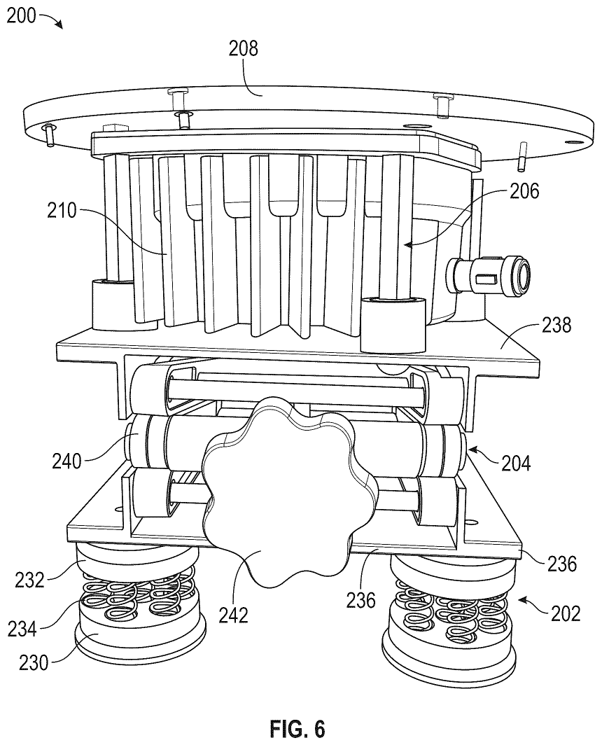

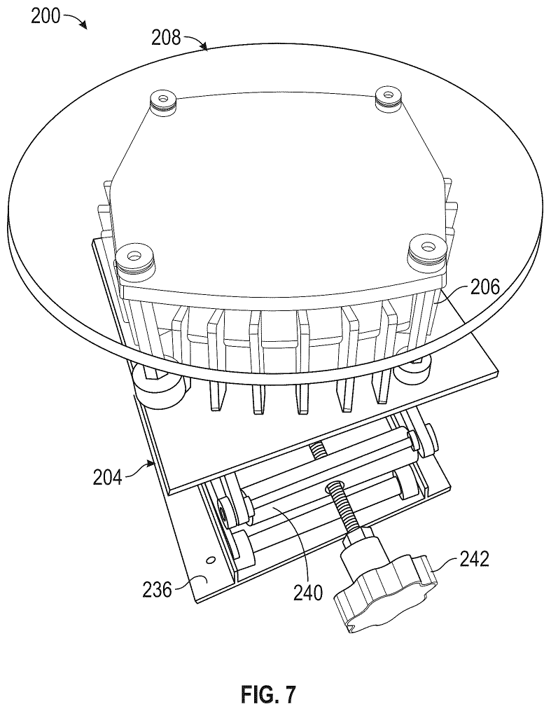

FIGS. 6 through 8 illustrate another example vibratory device 200. The vibratory device 200 is similar to the vibratory device 100 illustrated in FIGS. 1 through 5 described above, except as detailed below. Components below that lack a reference number are the same elements described in the first example vibrator device 100 and function in the same manner as described above.

The vibratory device 200 includes a plurality of vibration isolators 202, a lift 204, a plurality of elongate members 206, a platform 208, and a transducer 210.

Each vibration isolator 202 of the plurality of vibration isolators 202 has a first portion 230, a second portion 232, and at least one spring 234 disposed between the first portion 230 and the second portion 232. In the illustrated embodiment, the first portion 230 comprises a base platform, the second portion 232 comprises a top platform, and each vibration isolator 202 includes six springs 234 disposed between the first portion 230 and the second portion 232. However, any suitable number of springs may be used including, but not limited to, one, three, four, five, seven, and nine.

In the illustrated embodiment, the lift 204 includes a lift base 236, a lift deck 238, lift arms 240 connecting the lift base 236 and the lift deck 238, and a lift actuator 242. The lift deck 238 is moveable between a first position and a second position by adjusting the lift actuator 242. The lift base 236 is attached to each of the vibration isolators 202 by a plurality of fasteners (not shown) adjacent to each corner of the lift base 236. However, in alternative embodiments, the lift base 236 can be attached to each of the vibration isolators 202 by an adhesive or any other suitable means. Further, in alternative embodiments, the vibration isolators 202 can be positioned in any suitable location on the lift base 236.

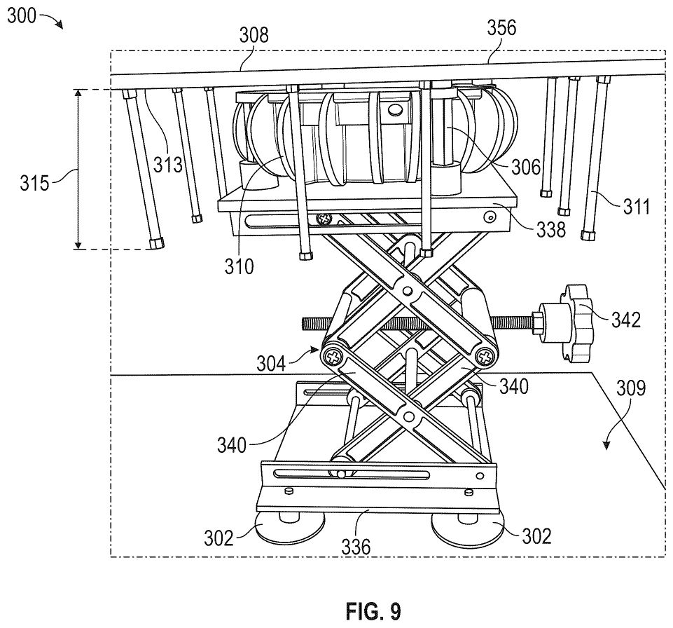

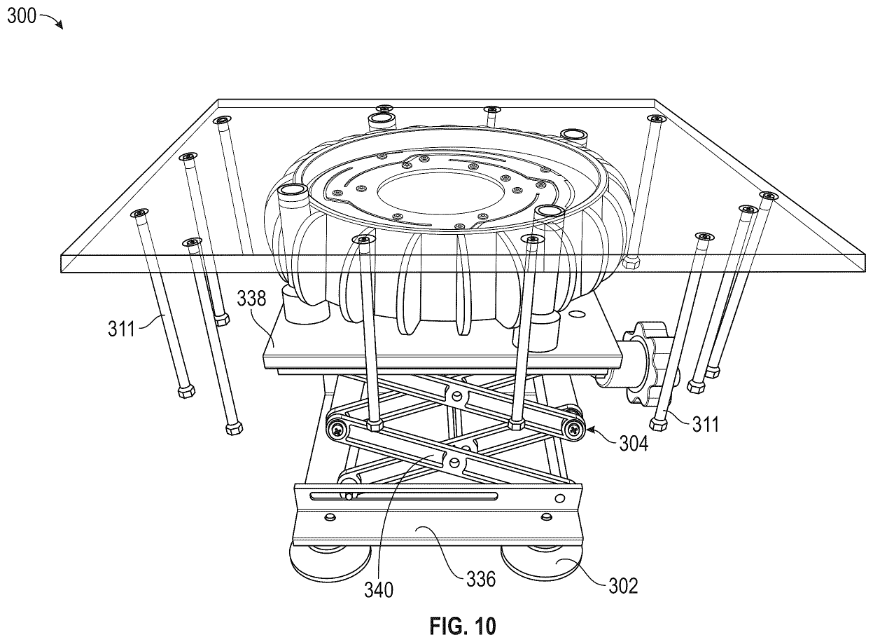

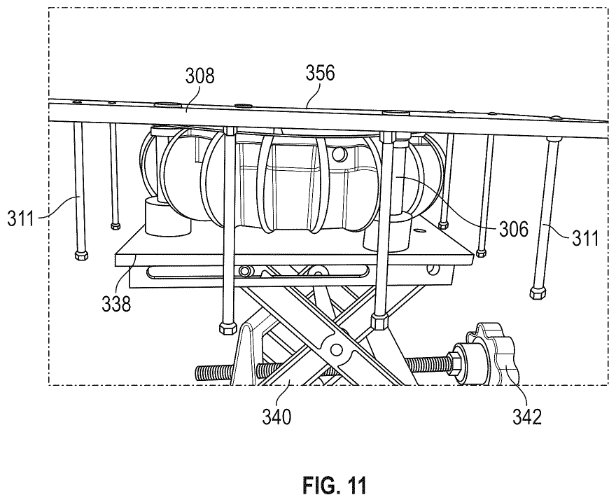

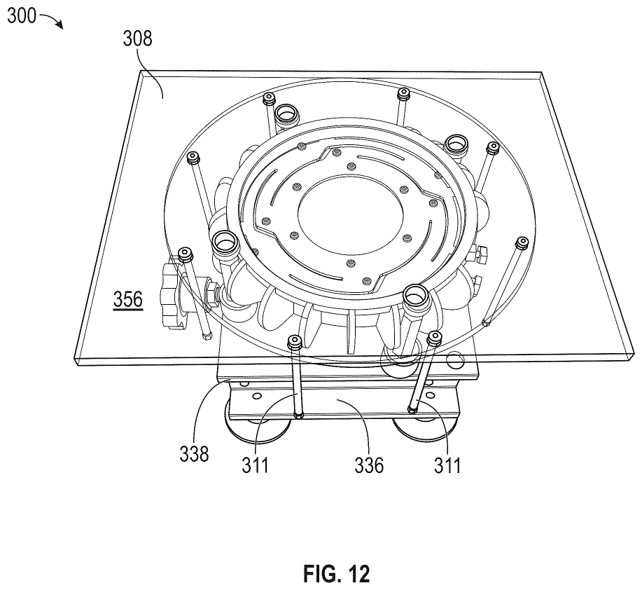

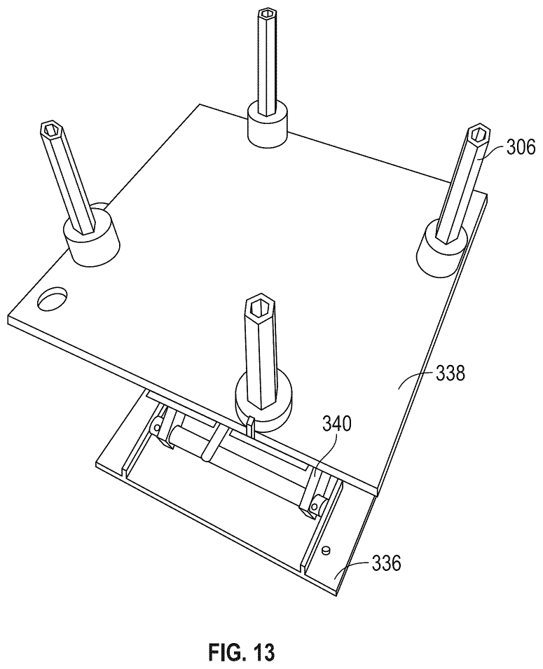

FIGS. 9 through 13 illustrate another example vibratory device 300. The vibratory device 300 is similar to the vibratory device 100 illustrated in FIGS. 1 through 5 described above, except as detailed below. Components below that lack a reference number are the same elements described in the first example vibrator device 100 and function in the same manner as described above.

The vibratory device 300 includes a plurality of vibration isolators 302, a lift 304, a plurality of elongate members 306, a platform 308, a transducer 310, and a plurality of guards 311.

Each vibration isolator 302 of the plurality of vibration isolators 302 is made from a rubberized material and provides separation between a surface 309 on which the vibratory device 300 is disposed and the lift 304.

In the illustrated embodiment, the lift 304 includes a lift base 336, a lift deck 338, lift arms 340 connecting the lift base 336 and the lift deck 338, and a lift actuator 342. The lift deck 338 is movable between a first position and a second position by adjusting the lift actuator 342. The lift base 336 is attached to each of the vibration isolators 302 by a plurality of fasteners (not shown) adjacent to each corner of the lift base 336. The plurality of elongate members 306 are each attached to the lift deck 338 and the platform 308. The platform 308 is attached to each elongate member 306 of the plurality of elongate members 306 using a fastener. In the embodiment shown, the platform 308 is a rectangular prism, has a top surface 356, and is formed of polycarbonate. However, the platform can be formed of any suitable material including, but not limited to, acrylic, polyamide, and polypropylene.

In the illustrated embodiment, the plurality of guards 311 extend from a platform bottom surface 313, away from the top surface 356 of the platform, and are positioned around the transducer 310. In the illustrated embodiment, there are eight guards 311. However, any suitable number of guards may be included in a vibratory device such as one, at least one, two, three, five, six, nine, more than nine, and any other number considered suitable for a particular embodiment. Each guard of the plurality of guards 311 is made from a polymer and has a length 315 that is greater that the distance between the lift deck 338 and the platform 308. Each guard of the plurality of guards 311 is approximately 65 mm to approximately 75 mm. However, a guard included on a vibratory device can have any suitable length. In alternative embodiments, a plurality of guards can be made from a metal or a rubber material and/or have a length that is less than the distance between a lift deck and a platform. Although each guard of the plurality of guards 311 is described as being made from a metal or a rubber, a guard can be made from any material suitable for a particular embodiment. Although the illustrated vibratory device 300 includes a plurality of guards, a vibratory device can include a single guard that extends from a platform bottom surface and circumferentially around a transducer. The inclusion of a plurality of guards 311 provides a mechanism for preventing interference to the transducer 310 by a child, an animal, toy, or any other object that might otherwise come in contact with the transducer 310.

FIG. 14 illustrates another example vibratory device 400. The vibratory device 400 is similar to the vibratory device 100 illustrated in FIGS. 1 through 5 described above, except as detailed below. Components below that lack a reference number are the same elements described in the first example vibrator device 100 and function in the same manner as described above.

The vibratory device 400 includes a plurality of vibration isolators 402, a lift 404, a plurality of elongate members 406, a platform 408, a transducer 410, and a plurality of guards 411.

The platform 408 is a cylinder, has a top surface 456 having a top surface length 454 of about 8 in., and is formed of a rubber material having a plurality of hexagonally shaped recesses 457. This style of platform 408 provides a mechanism for eliminating vibrational feedback and provides a thermal shield between two solid structures (e.g., the platform 408 and the surface to which the platform 408 is intended to contact) reducing heat between the structures.

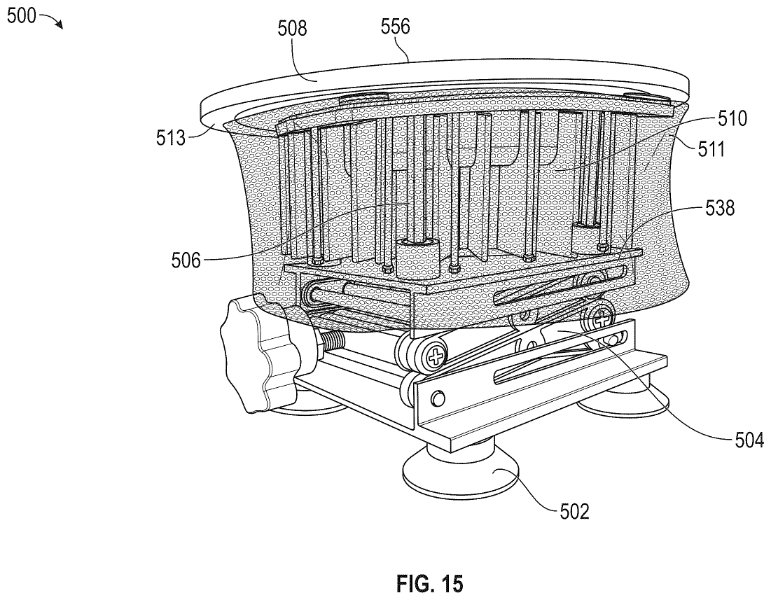

FIG. 15 illustrates another example vibratory device 500. The vibratory device 500 is similar to the vibratory device 100 illustrated in FIGS. 1 through 5 described above, except as detailed below. Components below that lack a reference number are the same elements described in the first example vibrator device 100 and function in the same manner as described above.

The vibratory device 500 includes a plurality of vibration isolators 502, a lift 504, a plurality of elongate members 506, a platform 508, a transducer 510, and a guard 511.

In the illustrated embodiment, the guard 511 is positioned circumferentially around the transducer 510 extending from a platform bottom surface 513 and away from the top surface 556 of the platform 508. In the illustrated embodiment, there is a single guard 511. The guard 511 is made from a net material and extends past the lift deck 538 when the lift deck 538 is in the first position. The guard 511 has a length of approximately 65 mm to approximately 75 mm. However, any suitable lengths may be used. In alternative embodiments, a guard can be made from a polymer, a metal, a rubber material, or any other suitable material and/or can have a length in which its end is disposed between a lift deck and a platform when the lift deck is in a first position.

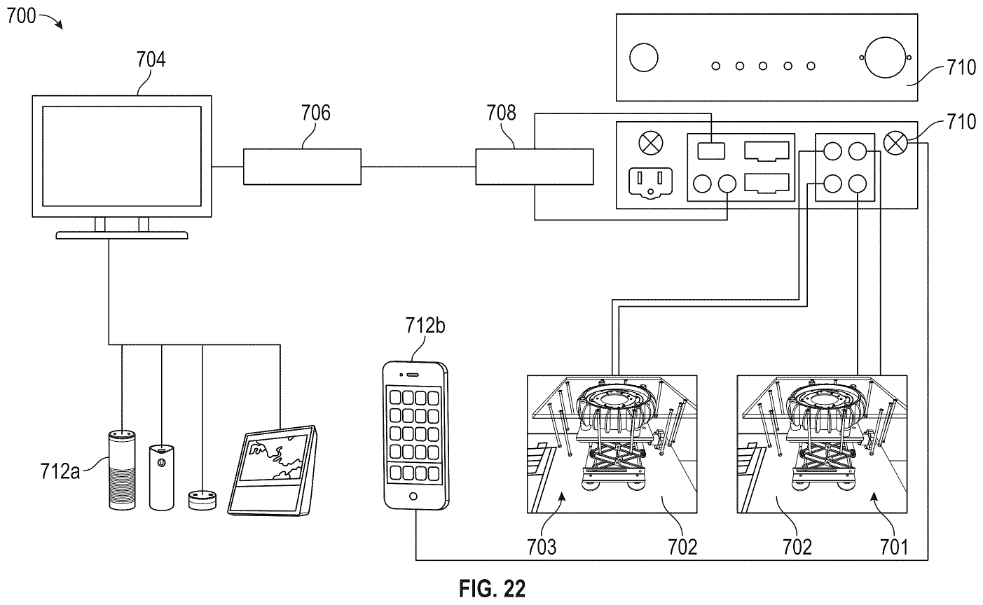

FIG. 22 illustrates a system 700 that includes at least one vibratory device 702, such as those described herein. In the illustrated embodiment, the system 700 includes a first vibratory device 701 and a second vibratory device 703. The system includes a television 704, a transmitter 706, a receiver 708, an amplifier 710, a first controller 712a, and a second controller 712b. In the illustrated embodiment, the television 704 is connected to a transmitter 706 which wirelessly transmits a signal to the receiver 708, which is received by the receiver 708. The receiver 708 is connected to the amplifier 710 and delivers the signal to the amplifier 710. The amplifier 710 is in a wired communication with the at least one vibratory device 702. However, in alternative embodiments an amplifier can be in a wireless communication with at least one vibratory device. The first controller 712a is in a wireless communication with the television 704 and the vibratory device (e.g., can adjust settings (e.g., power) of the at least one vibratory device 702). The first controller 712a is a smart device having voice controls. However, any suitable type of controller can be used. The amplifier 710 is in a wireless communication with the second controller 712b. The controller 712b can have a variety of functions including, but not limited to, adjusting the settings (e.g., power) of the at least one vibratory device 702. The second controller 712b is illustrated as a cellular device. However, the second controller 712 can be any suitable controller.

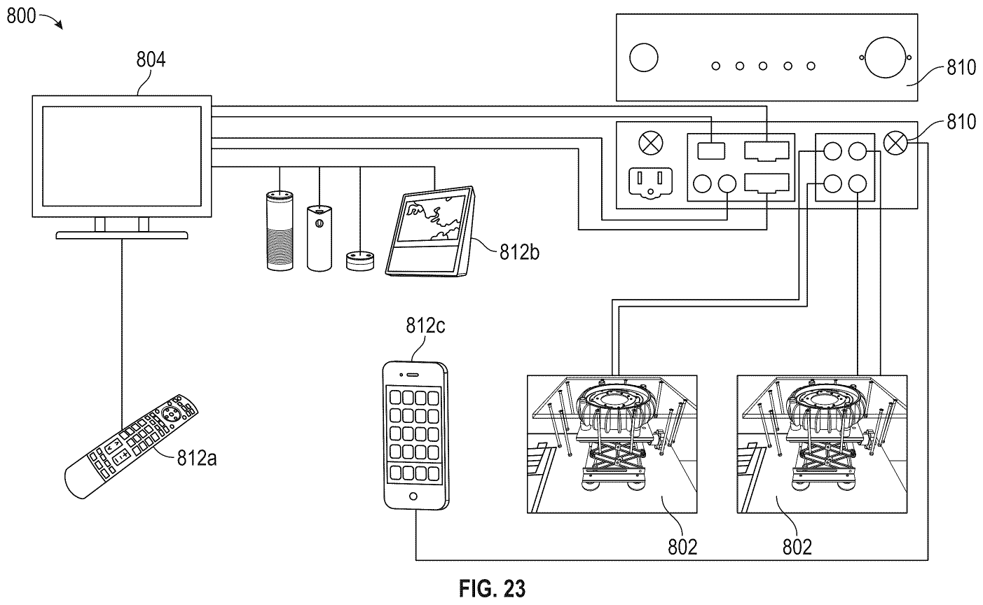

FIG. 23 illustrates another system 800 that includes at least one vibratory device 802, such as those described herein. In the illustrated embodiment, the system includes a television 804, an amplifier 810, a first controller 812a, a second controller 812b, a third controller 812c, and the at least one vibratory device 802. The system 800 is the same as the system illustrated in FIG. 22, except as described below.

In the illustrated embodiment, the television 804 is in a wired communication with the amplifier 810; however, the television 804 can be in a wireless communication with the amplifier 810 by any suitable type of wireless communication. The amplifier 810 is also in a wireless communication with the third controller 812c, and the third controller 812c can be used to adjust the power delivered to the amplifier 810. The third controller 812c is illustrated as a cellular device; however, any suitable controller can be used. The connection between the third controller 812c and the amplifier 810 can be a wired connection.

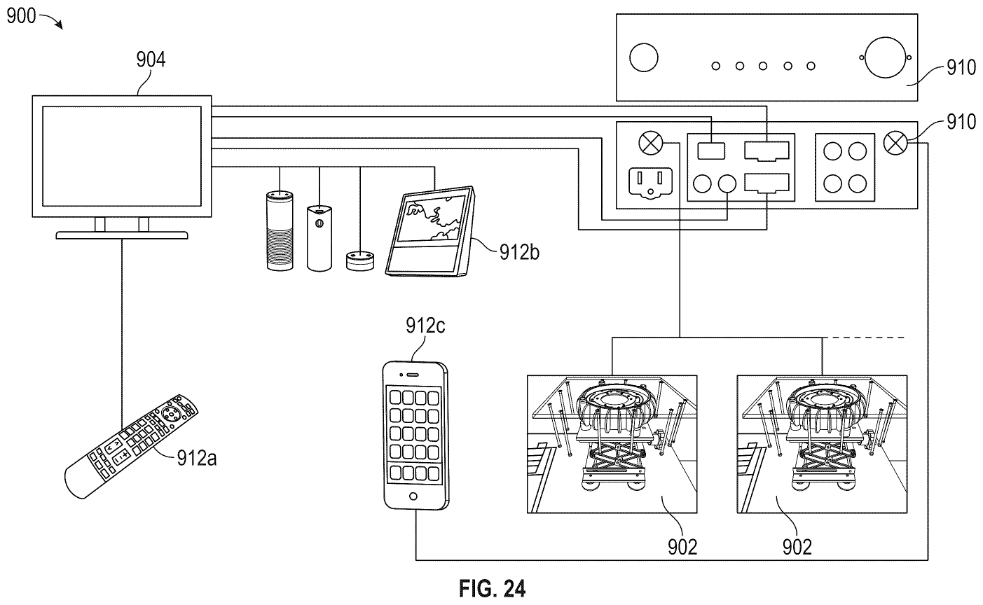

FIG. 24 illustrates another system 900 that includes at least one vibratory device 902, such as those described herein. In the illustrated embodiment, the system includes a television 904, an amplifier 910, a first controller 912a, a second controller 912b, a third controller, 912c, the at least one vibratory device 902, and a power supply (not illustrated). The system 900 is the same as the system illustrated in FIG. 23, except that the at least one vibratory device 902 is in a wireless communication with the amplifier 910. Therefore, the at least one vibratory device 902 is in communication with a power supply that is either attached to the at least one vibratory device 902, or is in a wired communication with an external power supply.

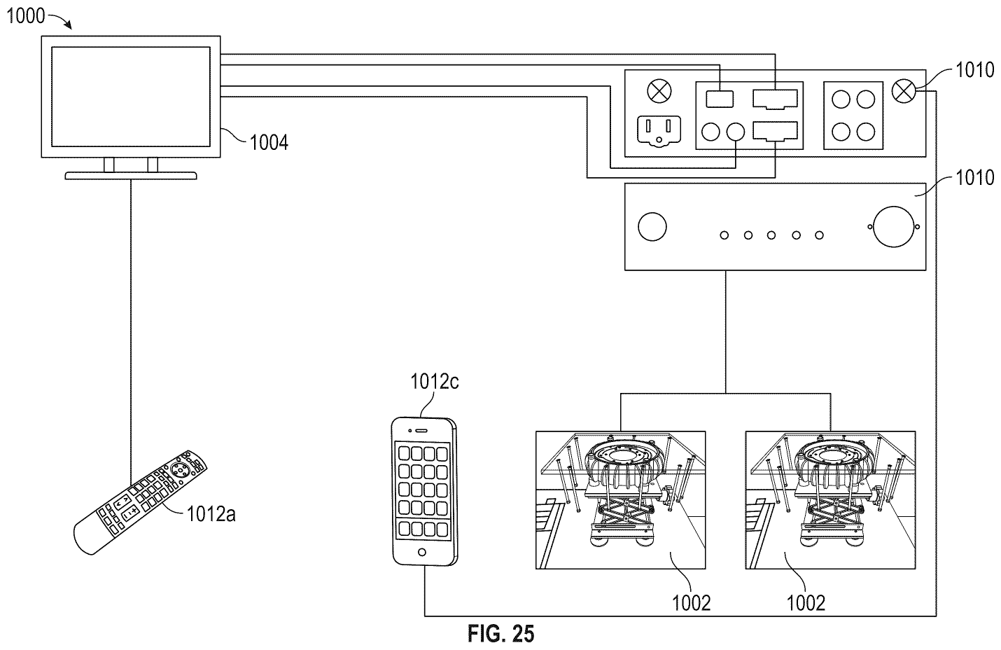

FIG. 25 illustrates another system 1000 that includes at least one vibratory device 1002. The system includes a television 1004, an amplifier 1010, a first controller 1012a, a third controller 1012c, the at least one vibratory device 1002, and a power supply. The system 1000 is the same as the system illustrated in FIG. 24 except that the second controller 912b is not present.

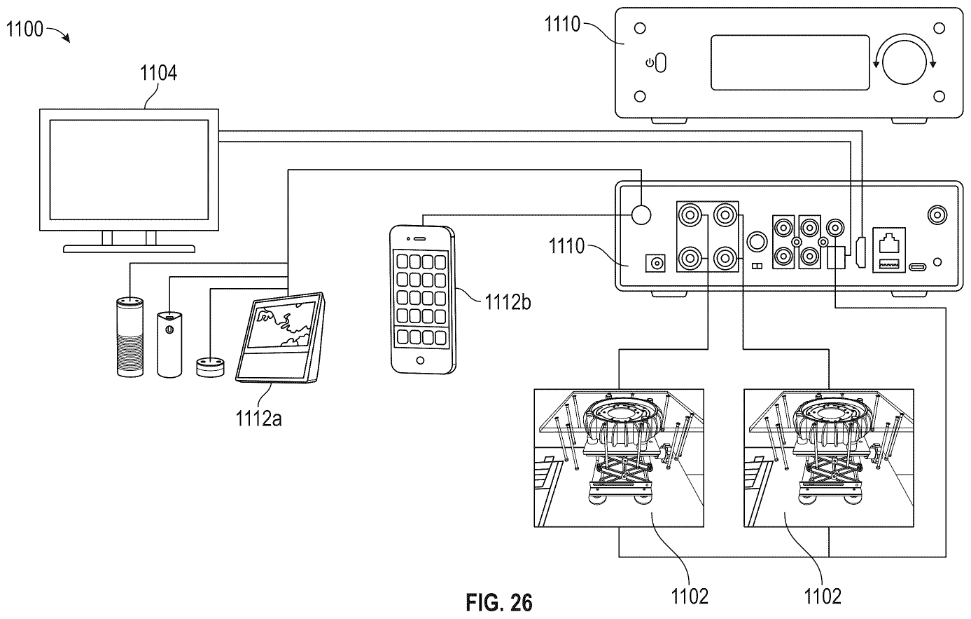

FIG. 26 illustrates another system 1100 that includes at least one vibratory device 1102. The system includes a television 1104, an amplifier 1110, a first controller 1012a, a second controller 1112b, and the at least one vibratory device 1102. The system 1100 is the same as illustrated in FIG. 22, except as described below.

In the embodiment shown, the television 1104 is in communication, wireless or wired by cable or Wi-Fi, with the amplifier 1110. The amplifier 1110 includes a power switch, an IR sensor, a display panel, a volume knob/input mode button, a BT antenna, a speaker out banana plug, a phono input, a subwoofer output, a HDMI ARC, a LAN, a WiFi Antenna, a reset, a USB type-A port, a USB type-C port, an optical input, a line input, a load switch, a ground connector, and/or a DC input. The amplifier 1110 can include connect inputs that can be connected to by a cable or to Wi-Fi to a router. The first controller 1112a and the second controller 1112b are handheld controls. The at least one vibratory device 1102 is in communication, wireless or wired (cable), with the amplifier 1110. Wireless communications can include, but are not limited to, IoT or Bluetooth. Also, the wireless communication between the amplifier 1110 and the at least one vibratory device 1102 can be daisy chained.

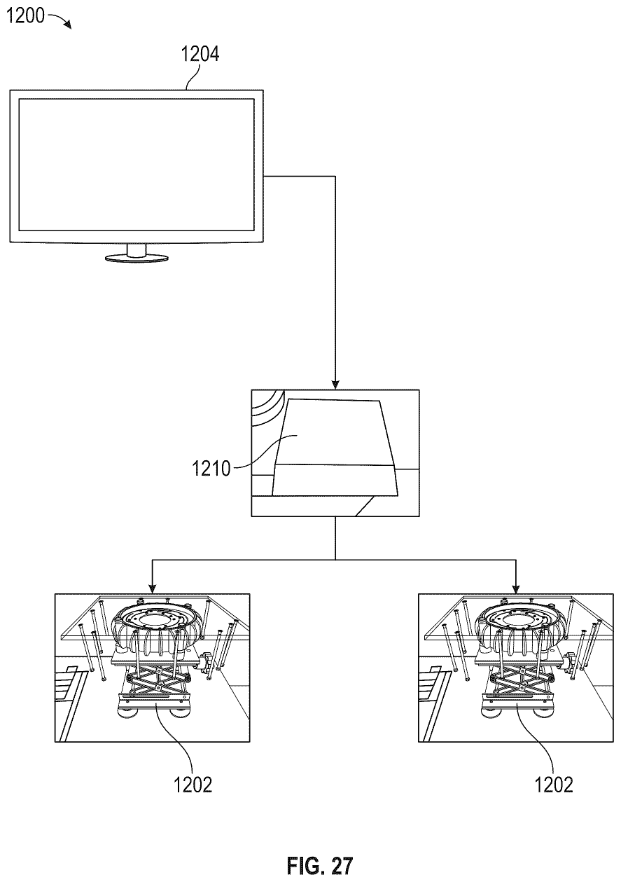

FIG. 27 illustrates another system 1200 that includes at least one vibratory devices 1202. The system includes a television 1204, an amplifier 1210, and the at least one vibratory device 1202. The television 1204 is in communication with the amplifier, wired or wireless. The television 1204 can be connected to the amplifier 1210 by optical out, RCA, or Bluetooth. The television 1204 sends a signal to the amplifier 1210. The amplifier 1210 then sends a signal to the at least one vibratory device 1202. The amplifier includes Bluetooth 5.x+, voice/apps, max bass/min treble, subwoofer circuits, and multiple inputs including RCA, Bluetooth, and optical.)

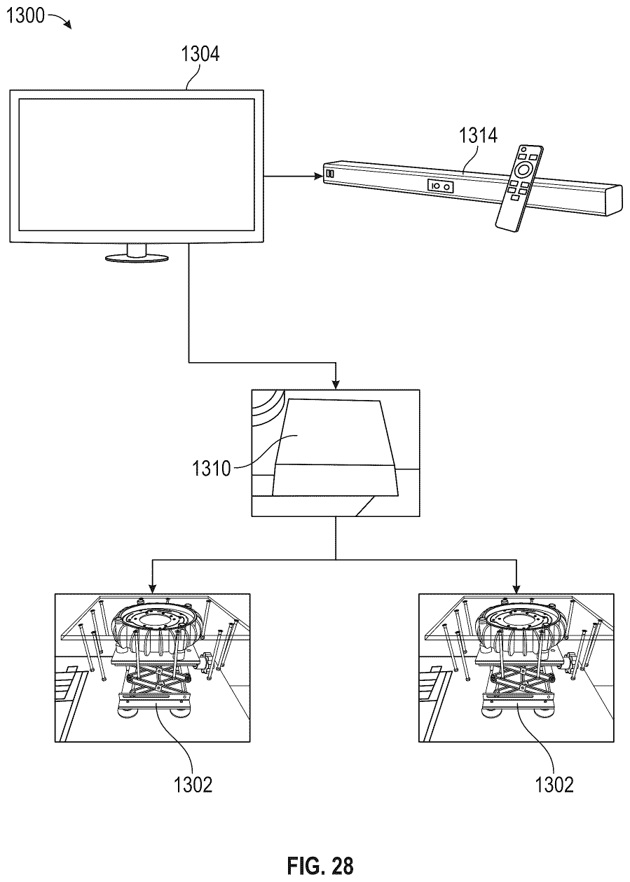

FIG. 28 illustrates another system 1300 that includes at least one vibratory device 1302. The system includes a television 1304, an amplifier 1310, a speaker 1314, and the at least one vibratory device 1302. The system 1300 is the same as illustrated in FIG. 27, except as described below.

In the illustrated embodiment, the system 1300 includes the speaker 1314 that is in communication with the television 1304. The television sends a signal to the speaker 1314 and the amplifier 1310. The speaker can be any type of speaker such as, but not limited to, a sound bar or a surround sound system. If the speaker 1314 and the amplifier 1310 are both connected via optical out, then a splitter (not illustrated) will be needed if using this specific amplifier.

A method of using a vibratory device includes the following steps. A step includes placing said vibratory device, such as those described herein, on a surface. Another step includes adjusting the lift of the vibratory device to be a first height in a first position. Another step comprises positioning the vibratory device at a location between a surface and a structure (e.g., couch, bed). Another step includes adjusting the lift of said vibratory device to be a second height in a second position, wherein the second height is greater than the first height. Another step includes connecting the transducer of said vibratory device to a receiver or amplifier. Another step comprises activating the vibratory device.

Those with ordinary skill in the art will appreciate that various modifications and alternatives for the described and illustrated examples can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. A vibratory device, comprising:
a vibration isolator;
a lift having a lift base and a lift deck, the lift base attached to the vibration isolator, the lift deck movable between a first position and a second position, the lift deck disposed a first distance from the lift base in the first position, the lift deck disposed a second distance from the lift base in the second position that is greater than the first distance;
a plurality of elongate members, each elongate member of the plurality of elongate members attached to the lift deck;
a platform attached to each elongate member of the plurality of elongate members; and
a transducer disposed between the lift deck and the platform.

2. The vibratory device of claim 1, further comprising a vibration feedback pad disposed on the platform.

3. The vibratory device of claim 1, wherein the transducer is free of contact with the lift and the platform.

4. The vibratory device of claim 1, wherein the transducer contacts each elongate member of the plurality of elongate members.

5. The vibratory device of claim 1, wherein the vibration isolator comprises a plurality of vibration isolators.

6. The vibratory device of claim 5, wherein the plurality of vibration isolators comprises four vibration isolators.

7. The vibratory device of claim 1, wherein the plurality of elongate members comprises four elongate members.

8. The vibratory device of claim 1, wherein each elongate member of the plurality of elongate members includes a first spacer.

9. The vibratory device of claim 8, wherein each elongate member of the plurality of elongate members includes a second spacer.

10. The vibratory device of claim 9, wherein the first spacer is free of contact with the second spacer.

11. The vibratory device of claim 9, wherein the transducer is disposed on, and contacts, the first spacer of each elongate member of the plurality of elongate members.

12. The vibratory device of claim 9, wherein the second spacer is disposed between the platform and the transducer.

13. The vibratory device of claim 1, wherein the lift is a scissor lift.

14. The vibratory device of claim 1, wherein the vibration isolator includes a spring.

15. The vibratory device of claim 1, wherein the vibration isolator includes a plurality of springs.

16. The vibratory device of claim 1, wherein the vibration isolator includes a foam pad.

17. The vibratory device of claim 1, further comprising a guard extending from the platform.

18. The vibratory device of claim 1, further comprising a plurality of guards extending from the platform.

19. A vibratory device, comprising:
a plurality of vibration isolators, each vibration isolator of the plurality of vibration isolators including a bracket having a first wing, a second wing, and a bracket base between the first wing and the second wing;
a lift having a lift base and a lift deck, the lift base attached to the bracket base of each vibration isolator, the lift deck movable between a first position and a second position, the lift deck disposed a first distance from the lift base in the first position, the lift deck disposed a second distance from the lift base in the second position that is greater than the first distance;
a plurality of elongate members, each elongate member of the plurality of elongate members attached to the lift deck;
a platform attached to each elongate member of the plurality of elongate members; and
a transducer disposed between the lift deck and the platform.

20. A method of using a vibratory device, the method comprising:
placing a vibratory device having a lift and a transducer on a surface;
adjusting the lift of the vibratory device to be a first height;
positioning said vibratory device at a location between a surface and a structure;
adjusting the lift of the vibratory device to be a second height, the second height being greater than the first height; and
connecting the transducer of said vibratory device to a receiver or an amplifier.
